(19) United States
(12) Patent Application Publication
(10) Pub. No.: US 2025/0230829 A1
(43) Pub. Date: Jul. 17, 2025

(54) Reinforcement Feature for a Routing Clip

(71) Applicant: Illinois Tool Works Inc., Glenview, IL (US)

(72) Inventors: Thomas A. Benoit, Bourbonnais, IL (US); Eric J. Kato, Naperville, IL (US); Kileean E. Bell, Monee, IL (US)

(21) Appl. No.: 19/011,181

(22) Filed: Jan. 6, 2025

Related U.S. Application Data
(60) Provisional application No. 63/620,993, filed on Jan. 15, 2024.

(51) Int. Cl. F16B 7/04

(52) U.S. Cl. CPC F16B 7/0406

(57) ABSTRACT

Described is a tube retainer for securing at least one tube relative to a component. The tube retainer includes a first wall, a second wall spaced from said first wall, a tube pocket, and a reinforcement brace. The tube pocket is positioned between the first wall and the second wall. The tube pocket receives the tube. The reinforcement brace is formed on the outer surface of said first wall that is opposite the tube pocket.

### RELATED APPLICATION

The present application claims priority to U.S. Provisional Patent Application No. 63/620,993, filed Jan. 15, 2024, and entitled “Reinforcement Feature for a Routing Clip,” which is hereby incorporated by reference in its entirety.

### BACKGROUND

Automotive components require fastening techniques that are simple to manufacture and assemble. Further, fastening techniques should above all be reliable and efficient.

In some instances, objects need to be secured to the vehicle to mitigate movement and/or shifting during operation, which can result in damage or kinking to the object. For example, tube, hoses, wires, and other conduits are often secured to the vehicle components.

Despite advancements to date, it would be desirable to have a tube retainer assembly with improved assembly characteristics.

### SUMMARY

The present disclosure relates generally to a fastening system to form a connection between the components, such as tubes and automotive panels, using a tube retainer with improved characteristics, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIGS. 1a through 1c illustrate a fastening system configured to secure one or more tubes relative to a component via a tube retainer in accordance with aspects of this disclosure.

FIG. 2a illustrates a topside isometric view of the tube retainer of FIGS. 1a through 1c, while FIG. 2b illustrates an underside isometric view thereof.

FIGS. 2c and 2d illustrate, respectively, first and second side elevation views of the tube retainer.

FIGS. 2e and 2f illustrate, respectively, front and rear elevation views of the tube retainer.

FIGS. 2g and 2h illustrate, respectively, top plan and bottom plan views of the tube retainer.

FIG. 2i illustrates an underside isometric detailed view of the tube retainer.

FIG. 2j illustrates a topside isometric detailed view of the tube retainer.

FIG. 2k illustrates a side elevation detailed view of the tube retainer.

FIG. 3a illustrates a topside isometric view of a tube retainer in accordance with another aspect of this disclosure, while FIG. 3b illustrates an underside isometric view thereof.

FIGS. 3c and 3d illustrate, respectively, top plan and bottom plan views of the tube retainer.

FIGS. 3e and 3f illustrate, respectively, front and rear elevation views of the tube retainer.

FIGS. 3g and 3h illustrate, respectively, first and second side elevation views of the tube retainer.

FIG. 3i illustrates an underside isometric detailed view of the tube retainer.

FIG. 3j illustrates a topside isometric detailed view of the tube retainer.

FIG. 3k illustrates a side elevation detailed view of the tube retainer.

FIGS. 4a through 4f illustrate additional fastener styles suitable for coupling the retainer portion with the component in accordance with other aspects of this disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

A tube retainer can be used to couple an object to a component, such as automotive components. In one example, a tube retainer for securing a tube comprises: a tube pocket positioned between a first wall and a second wall, wherein the tube pocket is configured to receive the tube; and a reinforcement brace formed on a surface of said first wall that is opposite the tube pocket.

In some examples, the reinforcement brace comprises a rib portion and a buttress portion.

In some examples, a proximal end of each of the rib portion and the buttress portion is coupled to the first wall.

In some examples, the rib portion and the buttress portion are coupled to one another at a distal end thereof.

In some examples, the distal end of the rib portion is spaced apart from the distal end of the buttress portion to define a gap.

In some examples, the distal end of the rib portion is configured to move relative to the distal end of the buttress portion.

In some examples, the rib portion comprises a ledge configured to restrict movement of the distal end of the buttress portion relative to the rib portion.

In some examples, the rib portion is perpendicular to the first wall.

In some examples, the buttress portion is positioned between the first wall and the rib portion at an angle relative to the first wall.

In some examples, the tube retainer further comprises a second reinforcement brace formed on a surface of said second wall that is opposite the tube pocket.

In some examples, the tube retainer further comprises an opening configured to receive a stud, and one or more stud-retention features formed in the opening and configured to engage the stud.

In some examples, the tube retainer further comprises one or more wings resiliently connected to the first wall or the second wall and configured to prevent the tube from exiting the tube pocket.

In another example, a tube retainer for securing a tube relative to a component comprises: a retainer portion configured to secure the tube via a tube pocket positioned between a first wall and a second wall, wherein the retainer portion includes a reinforcement brace formed on a surface of said first wall that is opposite the tube pocket; and a fastener portion configured to couple with the component, and wherein the retainer portion and the fastener portion are fabricated as a unitary structure.

In some examples, the reinforcement brace comprises a rib portion and a buttress portion, and wherein a proximal end of each of the rib portion and the buttress portion is coupled to the first wall.

In some examples, the rib portion and the buttress portion are coupled to one another at a distal end thereof.

In some examples, the distal end of the rib portion is spaced apart from the distal end of the buttress portion to define a gap.

In another example, a tube retainer for securing a tube comprises: a tube pocket positioned between a first wall and a second wall, wherein the tube pocket is configured to receive the tube; and a reinforcement brace formed on a surface of said first wall that is opposite the tube pocket, wherein reinforcement brace comprises a rib portion that is perpendicular to the first wall and a buttress portion that is traverse to the rib portion.

In some examples, the distal end of the rib portion is spaced apart from a distal end of the buttress portion to define a gap such that the distal end of the rib portion is configured to move relative to the distal end of the buttress portion.

In some examples, the rib portion comprises a ledge configured to restrict movement of the distal end of the buttress portion relative to the rib portion.

In some examples, the tube retainer further comprises one or more wings resiliently connected to the first wall or second wall and configured to prevent the tube from exiting the tube pocket.

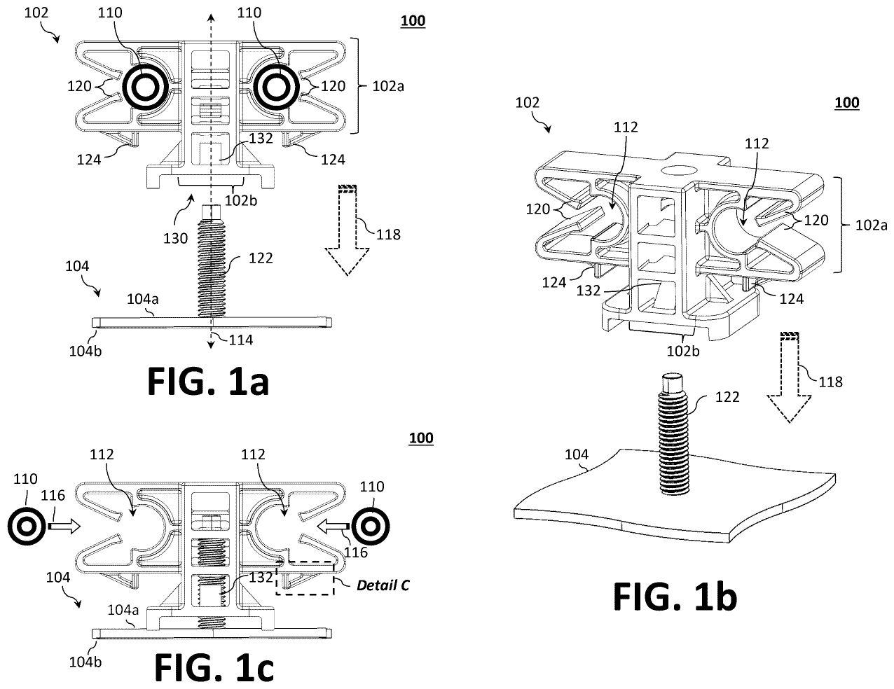

FIGS. 1a through 1c illustrate side views of an example fastening system 100 configured to secure one or more tubes 110 relative to a component 104 having a stud 122 thereon via a tube retainer 102. FIGS. 1a and 1b illustrate assembly views, while FIG. 1c illustrates an assembled view. The one or more tubes 110 may be, for example, brake lines, fuel lines, cables (e.g., electric cables), pipes, and/or any other tubular structure that may be secured to a component 104. As illustrated, the component 104 defines an A-side surface 104a (e.g., a first surface, such as an exterior surface) and a B-side surface 104b (e.g., a second surface, such as an interior surface). The one or more tubes 110 are illustrated as being secured to the A-side surface 104a.

The component 104 may be, for example, an automotive panel, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Depending on the application, the component 104 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof.

As best illustrated in FIGS. 1a through 1c, the component 104 may include, define, or otherwise provide the stud 122, which may be formed during manufacturing of the component 104 or attached during assembly. During installation, the fastener portion 102b of the tube retainer 102 is inserted over and slides onto the stud 122 formed in or on a surface of the component 104 as indicated by the arrow 118 to engage the stud-retention features 132. In the illustrated example, the stud 122 is threaded (or ribbed) to increase fastening strength once assembled by increasing the friction between the stud 122 and the stud-retention features 132.

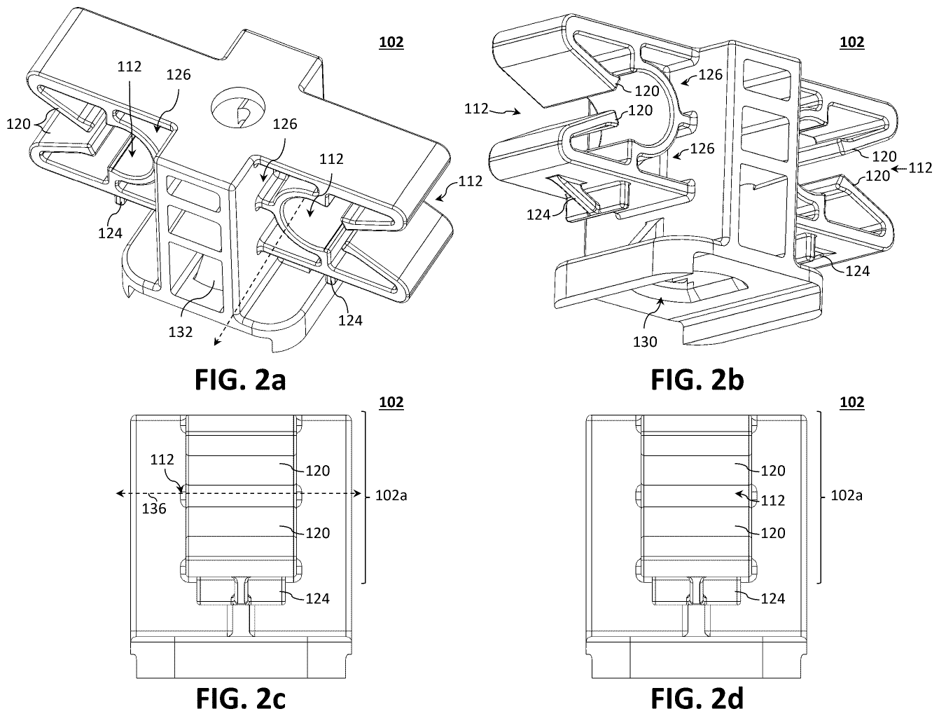

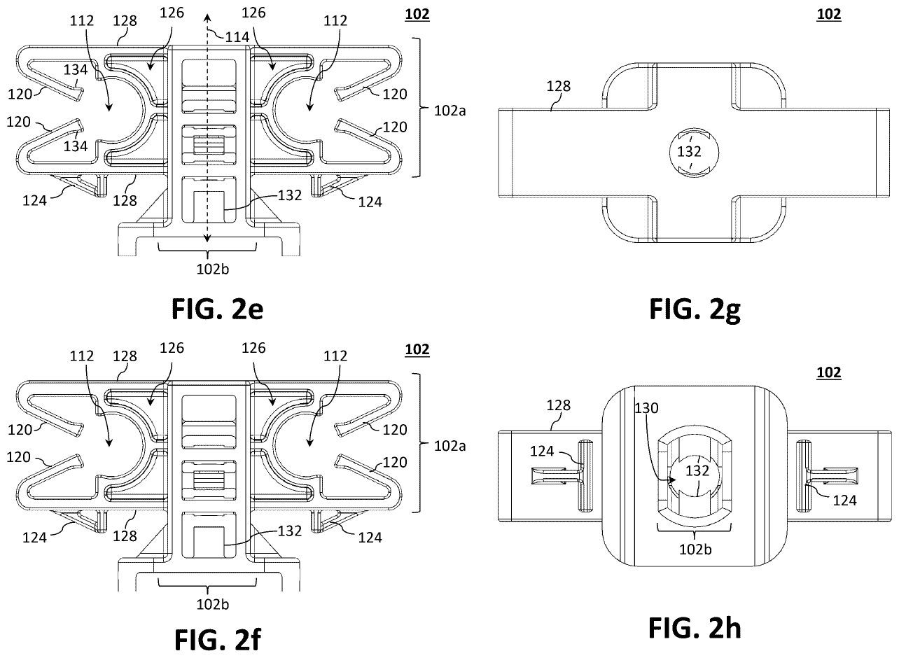

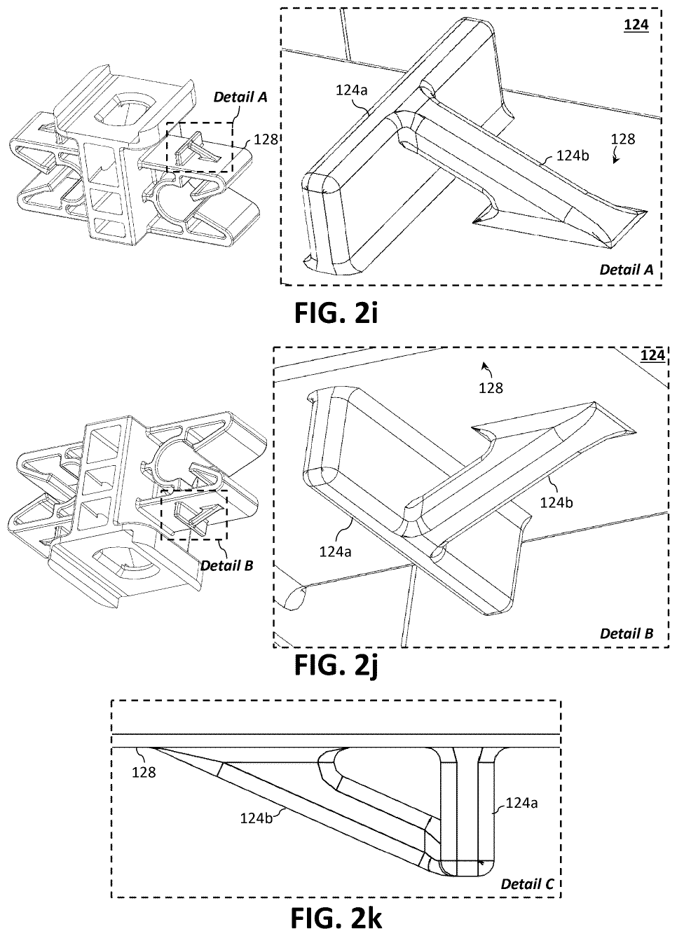

FIG. 2a illustrates a topside isometric view of the tube retainer 102 of FIGS. 1a through 1c, while FIG. 2b illustrates an underside isometric view thereof. FIGS. 2c and 2d illustrate, respectively, first and second side elevation views of the tube retainer 102. FIGS. 2e and 2f illustrate, respectively, front and rear elevation views of the tube retainer 102. FIGS. 2g and 2h illustrate, respectively, top plan and bottom plan views of the tube retainer 102. FIGS. 2i and 2k illustrate, respectively, underside and topside isometric detailed views of the tube retainer 102, while FIG. 2k illustrates a side elevation detailed view of the tube retainer 102.

The tube retainer 102 may include, define, or otherwise provide a retainer portion 102a and a fastener portion 102b. The retainer portion 102a is configured to couple with and/or secure the tubes 110 relative to one another and, ultimately, the component 104. For example, the retainer portion 102a is illustrated with a plurality of tube pockets 112 positioned between adjacent, spaced-apart walls 128, each of the plurality of tube pockets 112 is configured to secure a tube 110. In the illustrated example, the tube pocket 112 is shaped to compliment the exterior shape/contour of the tub 110. As illustrated, each of the plurality of tube pockets 112 can be shaped as a channel that generally corresponds to the diameter of the tubes 110. A tube 110 can be inserted into and secured within each of the plurality of tube pockets 112 by pushing the tube 110 toward the respective tube pocket 112 in the direction indicated by arrow 116. While two tube pockets 112 are illustrated, additional or fewer tube pockets 112 may be provided depending on the design needs (e.g., the number of tubes 110 that need to be secured). The width of the retainer portion 102a would be adjusted accordingly to accommodate the desired number of tube pockets 112 and/or tubes 110.

The fastener portion 102b of the illustrated tube retainer 102 serves to couple the retainer portion 102a to the component 104. As illustrated, the fastener portion 102b is generally perpendicular to the retainer portion 102a such that a central longitudinal axis 114 runs down the center of the fastener portion 102b. The tube retainer 102 illustrated In FIGS. 1a through 1c can secure to a stud 122 (e.g., a post) via the fastener portion 102b. To that end, fastener portion 102b includes an opening 130 sized to receive the stud 122 and one or more stud-retention features 132 formed in the opening 130 and configured to engage the stud 122. As illustrated, the plurality of stud-retention features 132 extend inwardly toward the central longitudinal axis 114 to grip the stud 122. To form the connection with the component 104, the fastener portion 102b of the tube retainer 102 is slipped onto the stud 122 formed on a surface of the component 104 as indicated by the arrow 118.

The fastener portion 102b can be integrated with the retainer portion 102a or attached during assembly (e.g., via adhesives, a welding process, a mechanical coupling, or the like). In some examples, the tube retainer 102 may include additional features, such as ribs and wings to mitigate noise and/or rattle between the tube retainer 102 and the component 104. In other examples, depending on the material type, the fastener portion 102b can be omitted and retainer portion 102a may be formed on or integrated with the component 104 during manufacturing of the component 104, whether via printing (e.g., an addition manufacturing process), molding, or layup. By integrating the retainer portion 102a with the component 104, the fastening system 100 eliminates setup variation, reduces the number of parts (and part numbers), and obviates the needs for the fastener portion 102b. Similarly, in some applications, it may be desirable to secure a plurality of tubes 110 relative to one another, but not necessary to secure them to the component 104. In such cases, the fastener portion 102b can be omitted.

The tube retainer 102 may be formed as a unitary structure. For example, the tube retainer 102 may be a printed thermoplastic material component that can be printed with great accuracy and with numerous details, which is particularly advantageous, for example, in creating components requiring complex and/or precise features. In addition, additive manufacturing techniques obviate the need for mold tooling typically associated with plastic injection molding, thereby lowering up-front manufacturing costs, which is particularly advantageous in low-volume productions. In some examples, the tube retainer 102 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

Additive manufacturing techniques print objects in three dimensions, therefore both the minimum feature size (i.e., resolution) of the X-Y plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (DPI) or micrometers (μm). The particles (3D dots) in the horizontal resolution can be around 50 to 100 μm (510 to 250 DPI) in diameter. Typical layer thickness (vertical resolution) is around 100 μm (250 DPI), although the layers may be as thin as 16 μm (1,600 DPI). The smaller the particles, the higher the horizontal resolution (i.e., higher the details the printer produces). Similarly, the smaller the layer thickness in Z-axis, the higher the vertical resolution (i.e., the smoother the printed surface will be). A printing process in a higher vertical resolution printing, however, will take longer to produce finer layers as the printer has to produce more layers. In some examples, the tube retainer 102 may be formed or otherwise fabricated at different resolutions during a printing operation. For example, the retainer portion 102a (or portions thereof) may be printed at a higher resolution than that of the fastener portion 102b or vice versa as needed for a particular application.

While it is contemplated that all portions of the tube retainer 102 would be formed during the same printing session (i.e., printed during the same printing operation), it is possible that the tube retainer 102 may be printed in two sessions. For example, the retainer portion 102a may be printed with one or more landmark structures (e.g., a protrusion or a recess) during a first session that can be located and filled and/or surrounded with material during a second session to form the fastener portion 102b.

As illustrated, the retainer portion 102a comprises a plurality of tube pockets 112 and a plurality of retainer wings 120. Each of the plurality of tube pockets 112 defines a central axis 136 that is perpendicular to the central longitudinal axis 114. When a tube 110 is inserted into the tube pocket 112, the length of the tube 110 aligns and/or is parallel to the central axis 136. In some examples, the tube retainer 102 comprises one or more windows 126 (e.g., cut outs or openings) formed in the retainer portion 102a and/or fastener portion 102b. For example, the body of the retainer portion 102a may be formed with one or more windows 126 that serve to reduce the amount of material needed to fabricate the tube retainer 102, thus reducing material cost and part weight.

Each of the plurality of tube pockets 112 is positioned between a set of spaced-apart walls 128 and secured via a set of retainer wings 120. For example, each tube pocket 112 is positioned between adjacent walls 128 (e.g., a first wall 128 and a second wall 128) and is configured to receive the tube 110.

As illustrated, each retainer wing 120 of the set of retainer wings 120 is coupled to and extends from one of the walls 128. The set of retainer wings 120 are oriented inwardly toward the tube pocket 112 at an angle and serve to prevent the tubes 110 from exiting the tube pocket 112. For example, the retainer wings 120 impart a force on the tube 110 in the direction indicated by arrow 116 to maintain the tube 110 in the tube pocket 112 (e.g., pressing the tube 110 into the tube pocket 112). In some examples, the retainer wings 120 can be embodied as “rabbit ears.”

The retainer wings 120 are resiliently coupled to a distal end of the wall 128 and configured to deflect as the tube 110 is passed into the tube pocket 112. The one or more retainer wings 120 are relatively rigid towards forces that oppose the insertion direction and, as such, will lock the tube 110 into the tube pocket 112. A foot 134 can be formed or located at an end of the wing 120b and configured to contact the tube 110. The foot 134 may be rounded or otherwise shaped (e.g., blunt) to mitigate damage to the tube 110.

The illustrated tube retainer 102 includes one or more reinforcement braces 124 formed on or integrated with the outer surface of one or more walls 128. The reinforcement brace 124 may be present on either or both walls 128 of a tube pocket 112. As illustrated, the reinforcement brace 124 can be formed on a surface of said first wall 128 and/or the second wall 128 that is opposite the tube pocket 112.

The illustrated reinforcement brace 124 comprises a rib portion 124a (e.g., a first section) and a buttress portion 124b (e.g., a second section). A proximal end of each of the rib portion 124a and the buttress portion 124b is coupled to the wall 128. The rib portion 124a is oriented such that it is perpendicular to the outer surface of the wall 128 and spans more than half the width of the tube retainer 102. The buttress portion 124b extends between the wall 128 and the rib portion 124a to provide a structural support by interfacing with the rib portion 124a.

The buttress portion 124b is angled relative to both the rib portion 124a and the wall 128, thereby increasing overall structural integrity of the tube retainer 102. In this example, the rib portion 124a is perpendicular to the first wall 128, while the buttress portion 124b is positioned between the first wall 128 and the rib portion 124a at an angle relative to the first wall 128. Thus, the illustrated buttress portion 124b follows an axis that transfers both the rib portion 124a and the wall 128. In this example, the rib portion 124a and the buttress portion 124b are coupled to one another at a distal end thereof.

The illustrated reinforcement brace 124 is configured to improve the rigidity of the tube retainer 102 at or near the tube pocket 112, resulting in increased pull-out resistance for the tube 110 when inserted into the tube pockets 112. This added rigidity enhances the functional reliability of the tube retainer while providing structural support to the wall 128. Despite the increase in pull-out force, the reinforcement brace 124 minimally affects the assembly process, ensuring that the push-in effort required to insert the tube 110 into the tube pocket 112 remains manageable. In addition, increasing the rigidity of the tube retainer 102 at or near the tube pocket 112 via the reinforcement brace 124 results in decreased insertion forces for installing the tube 110 into the tube pockets 112 as indicated by arrow 116.

Although the reinforcement braces 124 are illustrated with a generally triangular cross-section (see FIG. 2k), alternative cross-sectional shapes are also possible. These include, but are not limited to, semi-circular, square, rectangular, or other suitable geometries (whether with or without a gap 124d). The choice of cross-sectional shape may depend on the desired balance between structural strength and ease of assembly.

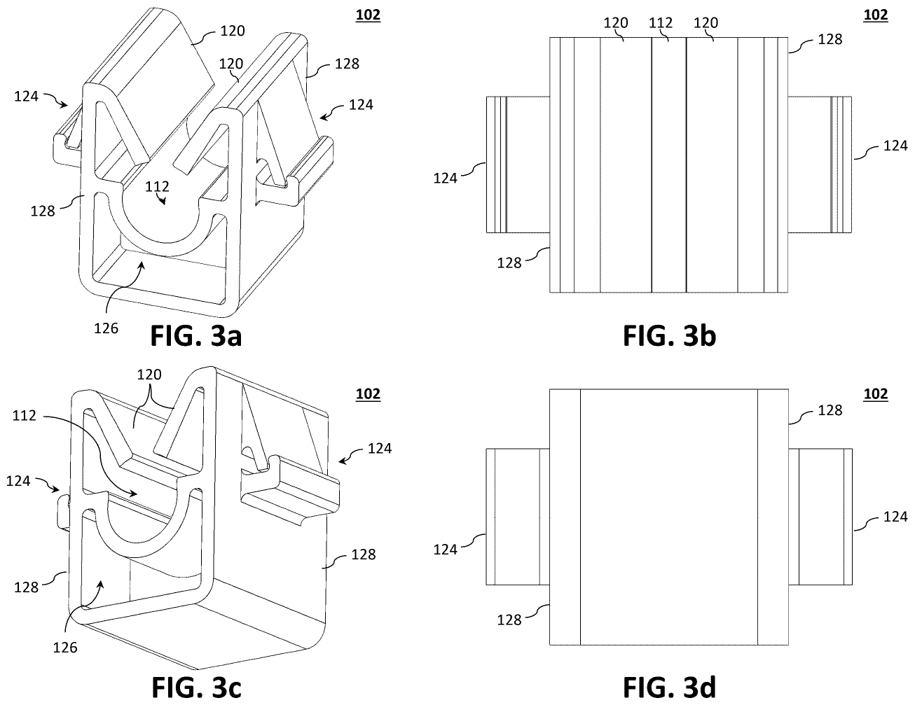

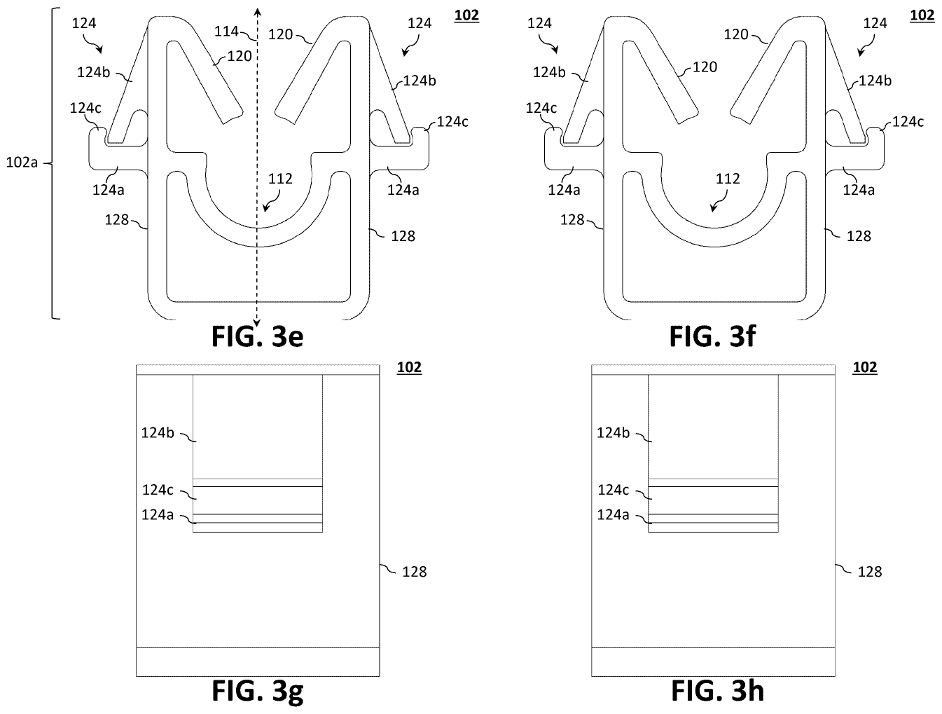

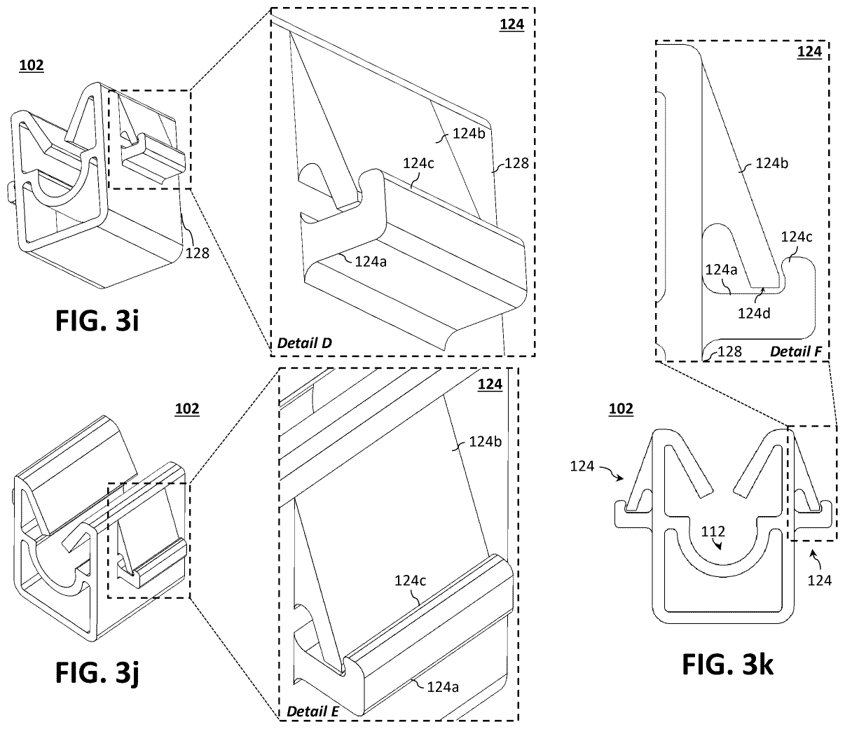

In this example, the buttress portion 124b is fixedly coupled to the rib portion 124a at the interface therebetween. In other examples, such as the example depicted and described in connection with FIGS. 3a through 3k, the buttress portion 124b and the rib portion 124a can be decoupled at the interface to define a gap 124d between the rib portion 124a and the buttress portion 124b. Furthermore, the rib portion 124a and the buttress portion 124b can be designed to span the full width of the tube retainer 102 or only a fraction thereof, ranging from 5% to 100% of the total width. As shown in FIGS. 2a through 2k, the rib portion 124a and the buttress portion 124b may feature differing widths. For example, as best shown in in FIG. 2i, the rib portion 124a may span nearly the entire width of the tube retainer 102 (e.g., 80 percent or more of the width of the wall 128), while the buttress portion 124b may span substantially less of the width of the tube retainer 102 (e.g., 25 percent or less of the width of the wall 128).

FIG. 3a illustrates a topside isometric view of a tube retainer 102 in accordance with another aspect of this disclosure, while FIG. 3b illustrates an underside isometric view thereof. FIGS. 3c and 3d illustrate, respectively, top plan and bottom plan views of the tube retainer 102. FIGS. 3e and 3f illustrate, respectively, front and rear elevation views of the tube retainer 102. FIGS. 3g and 3h illustrate, respectively, first and second side elevation views of the tube retainer 102. FIGS. 3i and 3j illustrate, respectively, underside and topside isometric detailed views of the tube retainer 102, while FIG. 3k illustrates a side elevation detailed view of the tube retainer 102.

The tube retainer 102 of FIGS. 3a through 3k is substantially similar to the tube retainer 102 of FIGS. 2a through 2k in terms of the structure, function, and operation of the tube pocket 112 and wings 120, but with certain differences. For example, the fastener portion 102b is omitted in the illustrated example. Additionally, the tube retainer 102 is configured with a single tube pocket 112 rather than two tube pockets 112. Further, reinforcement braces 124 are positioned on each wall 128 adjacent the tube pocket 112. Finally, the illustrated reinforcement braces 124 comprise a gap 124d interface between the rib portion 124a and the buttress portion 124b. That is, the distal end of the rib portion 124a is spaced apart from a distal end of the buttress portion 124b to define a gap 124d. The distal end of the rib portion 124a is therefore configured to move relative to the distal end of the buttress portion 124b during, for example, installation of the tube 110.

As best illustrated in FIG. 3k, the reinforcement braces 124 comprises a rib portion 124a coupled at its proximal end to the wall 128 and a buttress portion 124b coupled at its proximal end to the wall 128. The distal ends of the rib portion 124a and the buttress portion 124b are spaced to define the gap 124d therebetween when the tube retainer 102 in the resting state. When the wall 128 is exposed to forces (e.g., during installation of a tube 110 in the tube pocket 112), the wings 120 can bias the walls 128 s outwardly (away from the central longitudinal axis). The gap 124d permits the wall 128 to bias outwardly an amount before the distal end of the buttress portion 124b engages the rib portion 124a (closing the gap 124d).

The distal end of the buttress portion 124b is prohibited from slipping off the rib portion 124a via the illustrated ledge 124c. The rib portion 124a can therefore comprise a ledge 124c configured to restrict movement of the distal end of the buttress portion 124b relative to the rib portion 124a. The size of this gap 124d can be adjusted to fine-tune the pull-out force and/or mitigate the impact on push-in efforts. This adjustability provides a versatile design feature that can be tailored to meet specific application requirements.

In addition, unlike the prior example, the rib portion 124a and the buttress portion 124b may have the same width. For example, as best shown in in FIG. 3g, the rib portion 124a and the buttress portion 124b may span a majority of the width of the tube retainer 102 (e.g., over 50 percent of the width of the wall 128), This flexibility in design allows for customization of the reinforcement brace to suit a wide range of applications and performance criteria.

One of skill in the art would appreciate that the illustrated reinforcement braces 124 can be positions on various fasteners where there is a desire to increase rigidity and, as such, the reinforcement braces 124 should not be limited to use with the particular illustrated tube retainers 102.

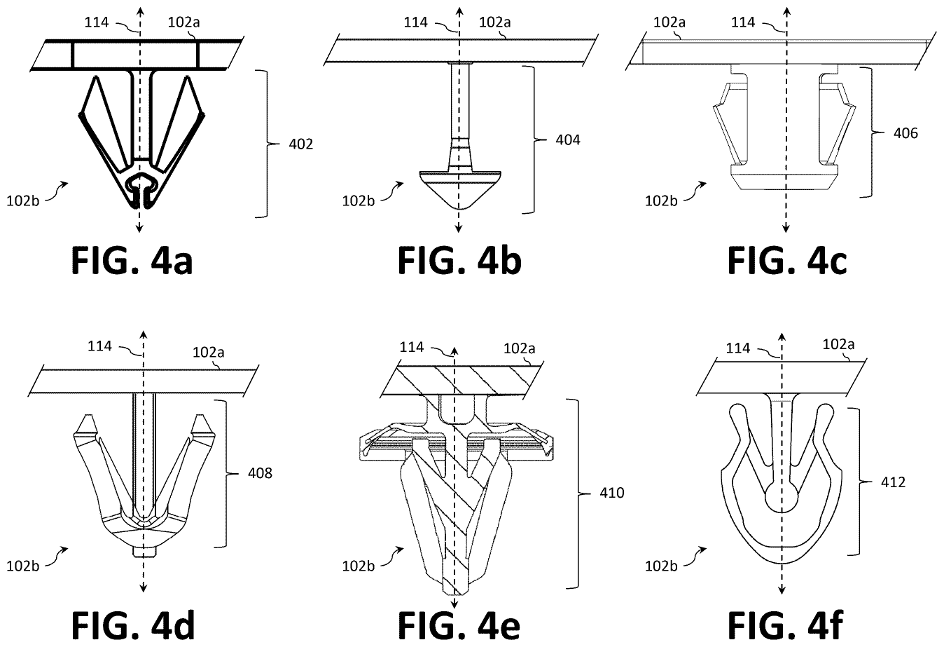

While the fastener portion 102b is illustrated in FIGS. 1a through 1c and FIGS. 2a through 2k as a post fastener (and the tube retainer 102 of FIGS. 3a through 3k omits the fastener portion 102b), other fastener designs are contemplated. For example, FIGS. 4a through 4f illustrate additional fastener styles that can be used as a fastener portions 102b for the aforementioned tube retainer 102 that are suitable for coupling the retainer portion 102a with the component 104. Specifically, FIGS. 4a through 4f illustrate, respectively, a W-shaped clip fastener 402 (illustrated as a 2-legged clip fastener), pin fastener 404, a box-prong fastener 406 (illustrated as a 2-legged box-prong fastener), a specialty clip assembly 408 (e.g., a CenterLok™ fastener, which is available from Deltar®), a clip assembly with four retaining legs 410, and an clip assembly with two snap-engaging seats 412. The clip assembly with four retaining legs 410, which is illustrated in FIG. 4e as a cross-sectional view, is further described in connection with commonly-owned U.S. Pat. No. 10,385,901 to Jeffrey J. Steltz. The clip assembly with two snap-engaging seats 412 of FIG. 4f is further described in connection with commonly-owned U.S. Pat. No. 10,018,214 to Fulvio Pacifico Yon.

The above-cited patents and patent publications are hereby incorporated by reference in their entirety. Where a definition or the usage of a term in a reference that is incorporated by reference herein is inconsistent or contrary to the definition or understanding of that term as provided herein, the meaning of the term provided herein governs and the definition of that term in the reference does not necessarily apply.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A tube retainer for securing a tube, the tube retainer comprising:
a tube pocket positioned between a first wall and a second wall, wherein the tube pocket is configured to receive the tube; and
a reinforcement brace formed on a surface of said first wall that is opposite the tube pocket.

2. The tube retainer of claim 1, wherein the reinforcement brace comprises a rib portion and a buttress portion.

3. The tube retainer of claim 2, wherein a proximal end of each of the rib portion and the buttress portion is coupled to the first wall.

4. The tube retainer of claim 3, wherein the rib portion and the buttress portion are coupled to one another at a distal end thereof.

5. The tube retainer of claim 3, wherein a distal end of the rib portion is spaced apart from a distal end of the buttress portion to define a gap.

6. The tube retainer of claim 5, wherein the distal end of the rib portion is configured to move relative to the distal end of the buttress portion.

7. The tube retainer of claim 6, wherein the rib portion comprises a ledge configured to restrict movement of the distal end of the buttress portion relative to the rib portion.

8. The tube retainer of claim 2, wherein the rib portion is perpendicular to the first wall.

9. The tube retainer of claim 2, wherein the buttress portion is positioned between the first wall and the rib portion at an angle relative to the first wall.

10. The tube retainer of claim 1, further comprising a second reinforcement brace formed on a surface of said second wall that is opposite the tube pocket.

11. The tube retainer of claim 1, further comprising an opening configured to receive a stud, and one or more stud-retention features formed in the opening and configured to engage the stud.

12. The tube retainer of claim 1, further comprising one or more wings resiliently connected to the first wall or the second wall and configured to prevent the tube from exiting the tube pocket.

13. A tube retainer for securing a tube relative to a component, the tube retainer comprising:
a retainer portion configured to secure the tube via a tube pocket positioned between a first wall and a second wall,
wherein the retainer portion includes a reinforcement brace formed on a surface of said first wall that is opposite the tube pocket; and
a fastener portion configured to couple with the component, and
wherein the retainer portion and the fastener portion are fabricated as a unitary structure.

14. The tube retainer of claim 13, wherein the reinforcement brace comprises a rib portion and a buttress portion, and wherein a proximal end of each of the rib portion and the buttress portion is coupled to the first wall.

15. The tube retainer of claim 14, wherein the rib portion and the buttress portion are coupled to one another at a distal end thereof.

16. The tube retainer of claim 3, wherein a distal end of the rib portion is spaced apart from a distal end of the buttress portion to define a gap.

17. A tube retainer for securing a tube, the tube retainer comprising:
a tube pocket positioned between a first wall and a second wall, wherein the tube pocket is configured to receive the tube; and
a reinforcement brace formed on a surface of said first wall that is opposite the tube pocket,
wherein reinforcement brace comprises a rib portion that is perpendicular to the first wall and a buttress portion that is traverse to the rib portion.

18. The tube retainer of claim 17, wherein a distal end of the rib portion is spaced apart from a distal end of the buttress portion to define a gap such that the distal end of the rib portion is configured to move relative to the distal end of the buttress portion.

19. The tube retainer of claim 18, wherein the rib portion comprises a ledge configured to restrict movement of the distal end of the buttress portion relative to the rib portion.

20. The tube retainer of claim 17, further comprising one or more wings resiliently connected to the first wall or second wall and configured to prevent the tube from exiting the tube pocket.
